(19) United States
(12) Patent Application Publication
(10) Pub. No.: US 2014/0302898 A1
(43) Pub. Date: Oct. 9, 2014

(54) WAGERING GAME HAVING A SKILL-COMPENSATION FEATURE

(71) Applicant: WMS Gaming Inc., Waukegan, IL (US)

(72) Inventor: Jamie W. Vann, Chicago, IL (US)

(73) Assignee: WMS Gaming Inc., Waukegan, IL (US)

(21) Appl. No.: 14/243,298

(22) Filed: Apr. 2, 2014

Related U.S. Application Data
(60) Provisional application No. 61/808,568, filed on Apr. 4, 2013.
(60) Provisional application No. 61/832,024, filed on Jun. 6, 2013.

(51) Int. Cl. G07F 17/32

(52) U.S. Cl. CPC G07F 17/326
USPC 463/2; 463/23; 463/20

(57) ABSTRACT

A gaming system and method includes receiving a wager input indicative of a wager to play a wagering game including a skill-based game. A skill-based input indicative of play of the skill-based game is received receive via at least one of the one or more input devices. A skill-level adjustment is applied to the skill-based game to decrease the skill-level needed to achieve an award outcome in the skill-based game. The skill-level adjustment includes compensating for the received skill-based input. An outcome of the skill-based game is determined. The outcome is based at least in part on the compensating for the received second input. In response to the outcome being an award outcome, an award is provided for the skill-based game.

### CROSS-REFERENCE TO RELATED APPLICATIONS

This application claims priority to and the benefits of U.S. Patent Application No. 61/808,568, filed Apr. 4, 2013 (Attorney Docket No. 247079-000869PL01) and U.S. Patent Application No. 61/832,024, filed Jun. 6, 2013 (Attorney Docket No. 247079-000869PL02), each of which are hereby incorporated by reference herein in their entireties.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming apparatuses and methods and, more particularly, to a wagering game apparatuses and methods including a skill-compensation feature.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player.

### SUMMARY OF THE INVENTION

According to one aspect of the present invention, a gaming system comprises one or more input devices, one or more display devices, one or more processors, and one or more memory devices storing instructions that, when executed by the one or more processors, cause the gaming system to receive, via at least one of the one or more input devices, a wager input indicative of a wager to play a wagering game including a skill-based game. A skill-based input indicative of play of the skill-based game is received via at least one of the one or more input devices. A skill-level adjustment is applied to the skill-based game to decrease the skill-level needed to achieve an award outcome in the skill-based game. The skill-level adjustment includes compensating for the received skill-based input. An outcome of the skill-based game is determined. The outcome is based at least in part on the compensating for the received skill-based input. In response to the outcome being an award outcome, an award is provided for the skill-based game.

According to another aspect of the invention, a computer-implemented method in a gaming system comprises receiving, via at one or more input devices, a wager input indicative of a wager. In response to receiving the wager input, a wagering game including a skill-based game is displayed on one or more display devices. A skill-based input indicative of play of the skill-based game is received via at least one of the one or more input devices. A skill-level adjustment to the skill-based game is determined via one or more processors. The skill-level adjustment decreases the skill-level needed to achieve an award outcome in the skill-based game by applying a compensation for the received skill-based input. An outcome of the skill-based game is determined via at least one of the one or more processors. The outcome is based at least in part on the compensation for the skill-based input. In response to the outcome being an award outcome, an award for the skill-based game is provided via at least one of the one or more processors.

According to yet another aspect of the invention, one or more computer readable storage media are encoded with instructions for directing a gaming system to perform the above methods.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming terminal according to an exemplary aspect of the present disclosure.

FIG. 2 is a schematic view of a gaming system according to an exemplary aspect of the present disclosure.

FIG. 3 is an image of an exemplary basic-game screen of a wagering game displayed on a gaming terminal, according to an exemplary aspect of the present disclosure.

FIG. 4 is an image of a bonus-game screen of a wagering game displayed on a gaming terminal, according to an exemplary aspect of the present disclosure.

FIGS. 5A and 5B are images of skill-based games of a wagering game illustrating a target-compensation adjustment feature, according to exemplary aspects of the present disclosure.

FIGS. 6A and 6B are images of skill-based games of a wagering game illustrating a player-input compensation adjustment feature, according to exemplary aspects of the present disclosure.

FIG. 7 is an image of another skill-based game of a wagering game illustrating another player-input compensation adjustment feature, according to an exemplary aspect of the present disclosure.

FIG. 8 is an image of a skill-based game of a wagering game illustrating a compensation feature for environmental factors in the skill-based game, according to an exemplary aspect of the present disclosure.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

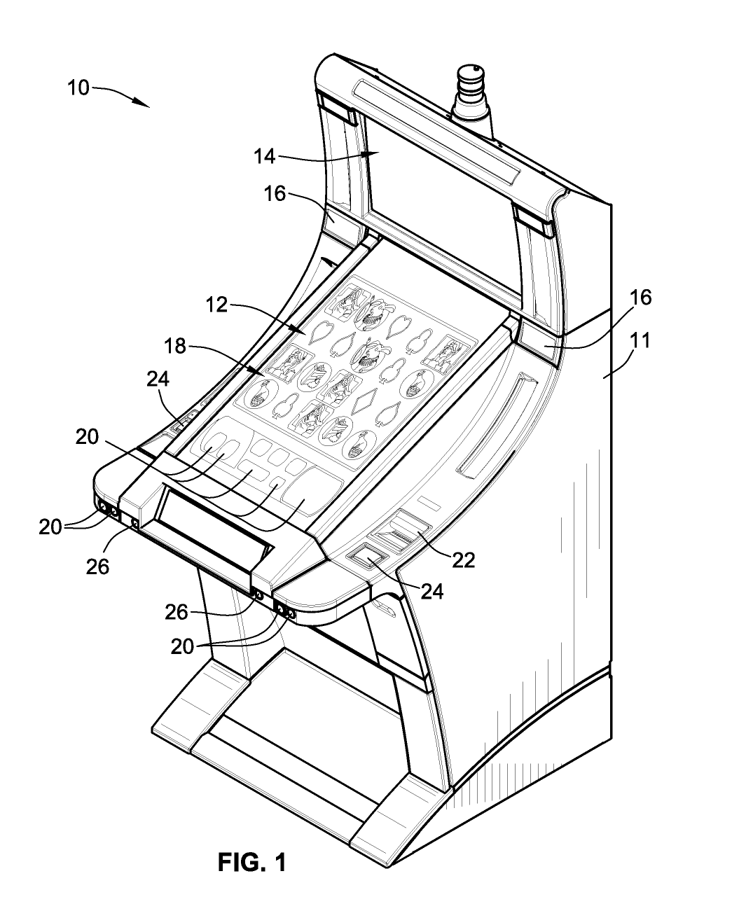

Referring to FIG. 1, there is shown a gaming terminal 10 similar to those used in gaming establishments, such as casinos. With regard to the present invention, the gaming terminal 10 may be any type of gaming terminal and may have varying structures and methods of operation. For example, in some aspects, the gaming terminal 10 is an electromechanical gaming terminal configured to play mechanical slots, whereas in other aspects, the gaming terminal is an electronic gaming terminal configured to play a video casino game, such as slots, keno, poker, blackjack, roulette, craps, etc. The gaming terminal 10 may take any suitable form, such as floor-standing models as shown, handheld mobile units, bartop models, workstation-type console models, etc. Further, the gaming terminal 10 may be primarily dedicated for use in conducting wagering games, or may include non-dedicated devices, such as mobile phones, personal digital assistants, personal computers, etc. Exemplary types of gaming terminals are disclosed in U.S. Pat. No. 6,517,433, titled “Reel Spinning Slot Machine With Superimposed Video Image,” U.S. Patent Application Publication Nos. US2010/0069160, titled “Handheld Wagering Game Machine And Docking Unit,” and US2010/0234099, titled “Wagering Game System With Docking Stations” which are incorporated herein by reference in their entireties.

The gaming terminal 10 illustrated in FIG. 1 comprises a cabinet 11 that may house various input devices, output devices, and input/output devices. By way of example, the gaming terminal 10 includes a primary display area 12, a secondary display area 14, and one or more audio speakers 16. The primary display area 12 or the secondary display area 14 may be a mechanical-reel display, a video display, or a combination thereof in which a transmissive video display is disposed in front of the mechanical-reel display to portray a video image superimposed upon the mechanical-reel display. The display areas may variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming terminal 10. The gaming terminal 10 includes a touch screen(s) 18 mounted over the primary or secondary areas, buttons 20 on a button panel, bill validator 22, information reader/writer(s) 24, and player-accessible port(s) 26 (e.g., audio output jack for headphones, video headset jack, USB port, wireless transmitter/receiver, etc.). It should be understood that numerous other peripheral devices and other elements exist and are readily utilizable in any number of combinations to create various forms of a gaming terminal in accord with the present concepts.

Input devices, such as the touch screen 18, buttons 20, a mouse, a joystick, a gesture-sensing device, a voice-recognition device, and a virtual input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a CPU for processing. The electronic data signals are selected from a group consisting essentially of an electrical current, an electrical voltage, an electrical charge, an optical signal, an optical element, a magnetic signal, and a magnetic element.

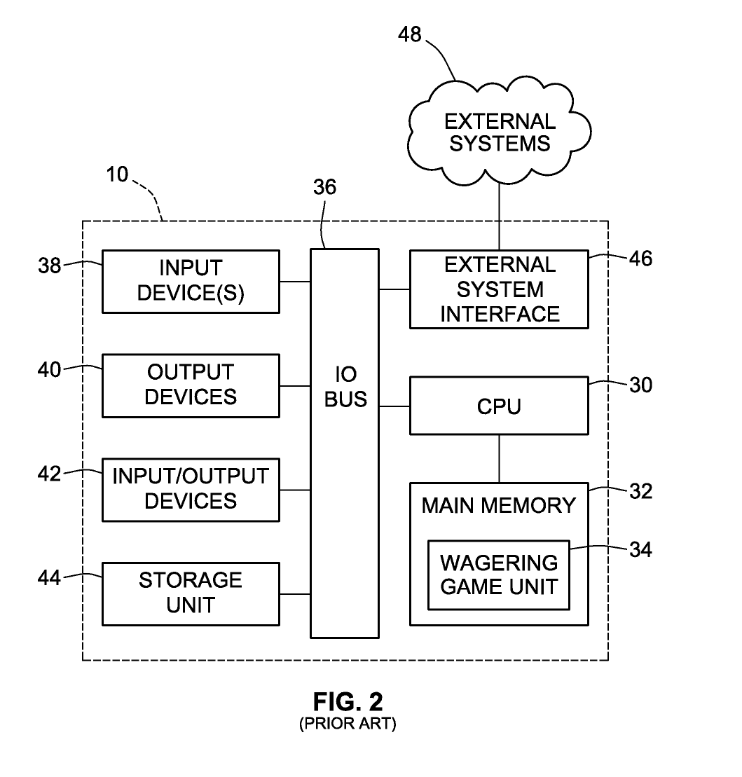

Turning now to FIG. 2, there is shown a block diagram of the gaming-terminal architecture. The gaming terminal 10 includes a central processing unit (CPU) 30 connected to a main memory 32. The CPU 30 may include any suitable processor(s), such as those made by Intel and AMD. By way of example, the CPU 30 includes a plurality of microprocessors including a master processor, a slave processor, and a secondary or parallel processor. CPU 30, as used herein, comprises any combination of hardware, software, or firmware disposed in or outside of the gaming terminal 10 that is configured to communicate with or control the transfer of data between the gaming terminal 10 and a bus, another computer, processor, device, service, or network. The CPU 30 comprises one or more controllers or processors and such one or more controllers or processors need not be disposed proximal to one another and may be located in different devices or in different locations. The CPU 30 is operable to execute all of the various gaming methods and other processes disclosed herein. The main memory 32 includes a wagering game unit 34. In one embodiment, the wagering game unit 34 may present wagering games, such as video poker, video black jack, video slots, video lottery, etc., in whole or part.

The CPU 30 is also connected to an input/output (I/O) bus 36, which can include any suitable bus technologies, such as an AGTL+ frontside bus and a PCI backside bus. The I/O bus 36 is connected to various input devices 38, output devices 40, and input/output devices 42 such as those discussed above in connection with FIG. 1. The I/O bus 36 is also connected to storage unit 44 and external system interface 46, which is connected to external system(s) 48 (e.g., wagering game networks).

The external system 48 includes, in various aspects, a gaming network, other gaming terminals, a gaming server, a remote controller, communications hardware, or a variety of other interfaced systems or components, in any combination. In yet other aspects, the external system 48 may comprise a player's portable electronic device (e.g., cellular phone, electronic wallet, etc.) and the external system interface 46 is configured to facilitate wireless communication and data transfer between the portable electronic device and the CPU 30, such as by a near-field communication path operating via magnetic-field induction or a frequency-hopping spread spectrum RF signals (e.g., Bluetooth, etc.).

The gaming terminal 10 optionally communicates with the external system 48 such that the terminal operates as a thin, thick, or intermediate client. In general, a wagering game includes an RNG for generating a random number, game logic for determining the outcome based on the randomly generated number, and game assets (e.g., art, sound, etc.) for presenting the determined outcome to a player in an audio-visual manner. The RNG, game logic, and game assets are contained within the gaming terminal 10 (“thick client” gaming terminal), the external system 48 (“thin client” gaming terminal), or are distributed therebetween in any suitable manner (“intermediate client” gaming terminal).

The gaming terminal 10 may include additional peripheral devices or more than one of each component shown in FIG. 2. Any component of the gaming terminal architecture may include hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic disk storage media, optical storage media, flash memory, etc.

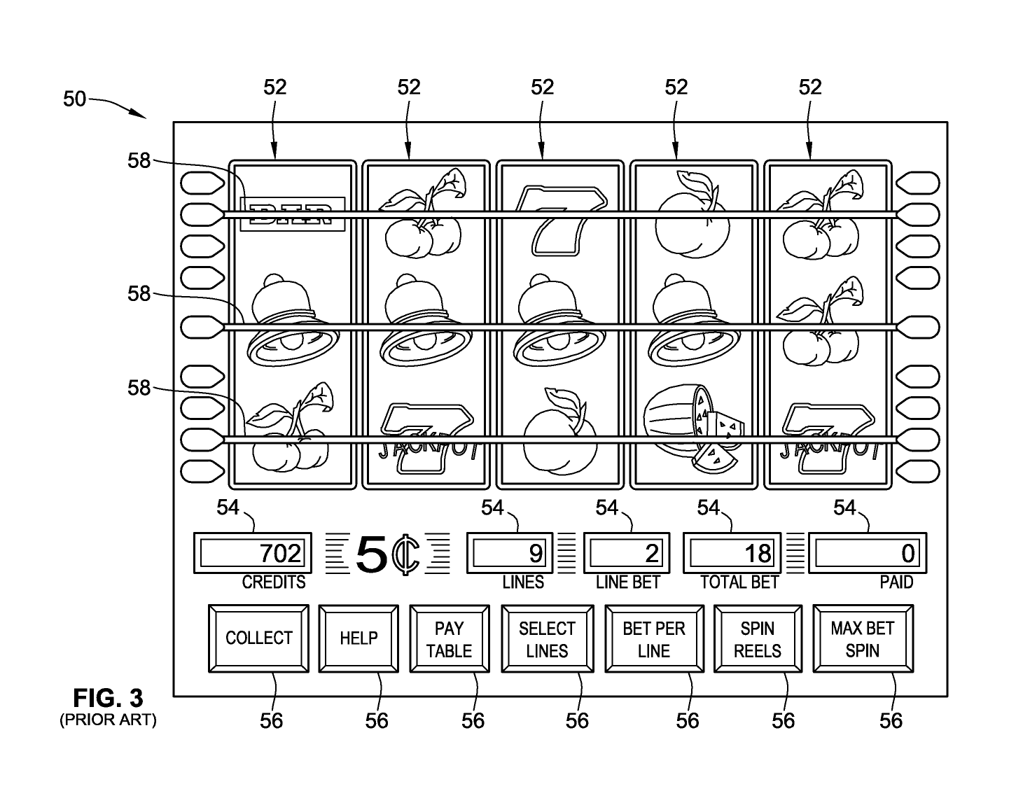

Referring now to FIG. 3, there is illustrated an image of a basic-game screen 50 adapted to be displayed on the primary display area 12 or the secondary display area 14. The basic-game screen 50 portrays a plurality of simulated symbol-bearing reels 52. Alternatively or additionally, the basic-game screen 50 portrays a plurality of mechanical reels or other video or mechanical presentation consistent with the game format and theme. The basic-game screen 50 also advantageously displays one or more game-session credit meters 54 and various touch screen buttons 56 adapted to be actuated by a player. A player can operate or interact with the wagering game using these touch screen buttons or other input devices such as the buttons 20 shown in FIG. 1. The CPU operate(s) to execute a wagering game program causing the primary display area 12 or the secondary display area 14 to display the wagering game.

In response to receiving an input indicative of a wager, the reels 52 are rotated and stopped to place symbols on the reels in visual association with paylines such as paylines 58. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering game outcome is provided or displayed in response to the wager being received or detected. The wagering game outcome is then revealed to the player in due course following initiation of the wagering game. The method comprises the acts of conducting the wagering game using a gaming apparatus, such as the gaming terminal 10 depicted in FIG. 1, following receipt of an input from the player to initiate the wagering game. The gaming terminal 10 then communicates the wagering game outcome to the player via one or more output devices (e.g., primary display 12 or secondary display 14) through the display of information such as, but not limited to, text, graphics, static images, moving images, etc., or any combination thereof. In accord with the method of conducting the wagering game, the CPU transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the CPU (e.g., CPU 30) is configured to process the electronic data signal, to interpret the data signal (e.g., data signals corresponding to a wager input), and to cause further actions associated with the interpretation of the signal in accord with computer instructions relating to such further actions executed by the controller. As one example, the CPU causes the recording of a digital representation of the wager in one or more storage media (e.g., storage unit 44), the CPU, in accord with associated computer instructions, causing the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM), etc. The noted second state of the data storage media comprises storage in the storage media of data representing the electronic data signal from the CPU (e.g., the wager in the present example). As another example, the CPU further, in accord with the execution of the instructions relating to the wagering game, causes the primary display 12, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of computer instructions relating to the wagering game is further conducted in accord with a random outcome (e.g., determined by a RNG) that is used by the CPU to determine the outcome of the game sequence, using a game logic for determining the outcome based on the randomly generated number. In at least some aspects, the CPU is configured to determine an outcome of the game sequence at least partially in response to the random parameter.

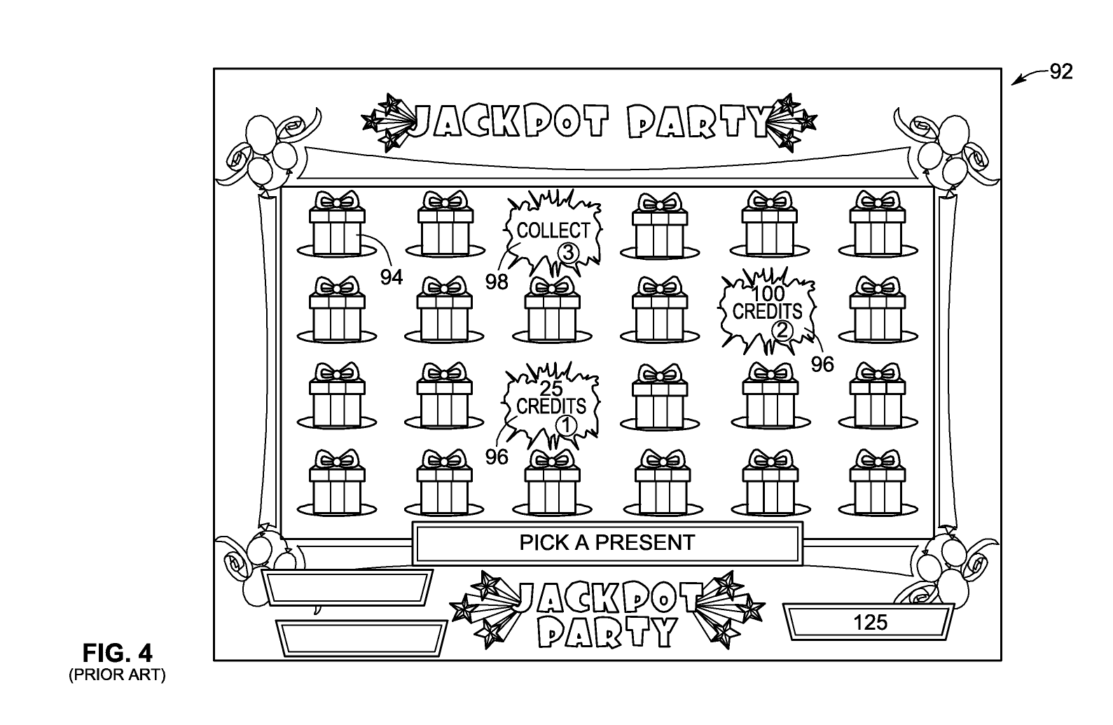

Turning now to FIG. 4, an example of a bonus game to a basic wagering game is illustrated. A bonus-game screen 92 includes an array of markers 94 located in a plurality of columns and rows. The bonus game is entered upon the occurrence of a triggering event, such as the occurrence of a start-bonus game outcome (e.g., symbol trigger, mystery trigger, time-based trigger, etc.) in or during the basic wagering game. Alternatively, any bonus game described herein is able to be deployed as a stand-alone wagering game independent of a basic wagering game.

In skill-based games, the skill a player applies during play of the game is directly related to the player's reward from the game. It can be a desirable aspect for skill-based games that the feel of the game include that the player's skill and the received reward be closely connected. According to some aspects, to make a game more broadly appealing, it may also be advantageous to compensate for a player's lack of skill in proportion to the player's wagering level. For example, the more a player wagers or the higher wager input received by a wagering machine, the less skill that may be needed to achieve an optimum outcome in an associated skill-based game.

A gaming system including a wagering game with an associated skill-based game can be configured to receive skill-based input(s) from a player via one or more input devices. The skill-based inputs can then be directly applied in determining an outcome of a skill-based game. It is further contemplated that an advantage can be applied to the skill-based portion of the wagering game based on how much a player is wagering. For example, the more a player wagers in the wagering game the greater an adjustment that is applied to a skill-based input received by the wagering machine to compensate for a player's lack of skill in the skill-based game portion of the wagering game. A player's true skill input can be taken and, based on the player's wager, a margin of error may then be given or some other compensation factor(s) may be applied that increase as a player's wager increases. In some aspects, if the minimum allowed bet is wagered for the wagering game, no compensation or adjustment is applied to the skill-based input received in a skill-based game. However, as a player's wager level increases, the adjustment that is applied to the skill-based input to compensate for the player's lack of skill also increases. The increase in the skill-based adjustment may be incremental and according to the player's wager level for the wagering game.

A wagering game can include any one of a variety of skill-based games. In some aspects, the skill-based game can include a target such as a shooting game target or an archery target where a player aims at targets in a virtual field and shoots a projectile at the target(s). The game may be configured where the player can set the aim at the target using a scope, such as one with crosshairs. In some aspects, a skill-based game is a sports game including a virtual playing field or course, such as a bowling game where a virtual bowling alley is displayed and where a player can manipulate the virtual bowling ball to knock down virtual pins or a gold game where a player manipulates a golf ball into the hole through received skill-based inputs. Other exemplary aspects of skill-based games can include a game where a player's goal is to either destroy or protect certain targeted icon(s) (e.g., a virtual character, vehicle, structure, or other object). An exemplary skill-based game can also include a virtual pinball game where a player manipulates a virtual pin ball to hit various targets or otherwise manipulates the pinball to move around the game environment.

It is contemplated that the skill-compensation feature(s) described for various aspects of the present disclosure are not scripted such that the outcome is not in favor of the player with a larger wager. Rather, the present disclosure contemplates that the player placing a wager meeting certain threshold wagering criteria will have a higher margin of error or an expanded target for their skill-based input. So, if a player's initial aim is off by more than the correction or compensation provide by the skill-compensation feature, the target can still be missed despite the skill-compensation feature being applied to the received skill-based input or the compensation adjustment applied to the target of the skill-based-input.

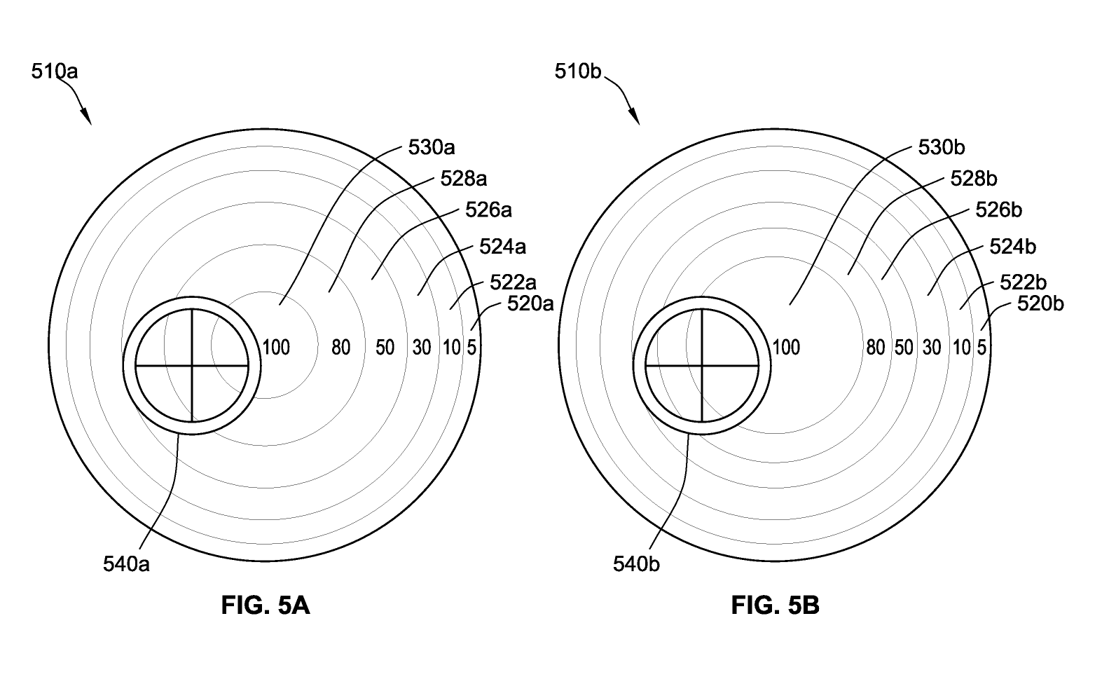

Referring now to FIGS. 5A and 5B, images of an exemplary skill-based game illustrate a target-compensation adjustment feature. The illustration provides an example of how an adjustment may be made to a skill-based game. The target-compensation adjustment is intended to increase a player's chance of achieving an award or increasing an otherwise lower award value to a higher one.

In FIG. 5A, an uncompensated target 510a is illustrated having several values 520a, 522a, 524a, 526a, 528a, 530a that a player can be credited depending on where the player's skill-based input is aimed at the target. For example, if the player aims and hits toward the center or bull's-eye 530a of the target, the player may be awarded 100 points. In the exemplary uncompensated target of FIG. 5A, the player has aimed the cross-hairs of a virtual scope 540a on ring 528a of target 510a, which after an input is received representing the player shooting a projectile to hit the target, will result in the wagering game awarding the player 80 points. However, if the player receives the benefit of a target-compensation adjustment feature, the rings of the target including the bull's eye may be adjusted as illustrated in the compensated target 510b of FIG. 5B. Virtual scope 540b is illustrated in the same position as virtual scope 540a for the uncompensated target 510a. However, the target-compensation adjustment feature expands the bull's eye 530a from the uncompensated target 510a so that it is larger, as illustrated by the bull's eye 540b in the compensated target 530b. Based on the compensated target, the player's skill-based input or aim, as identified by cross-hairs of scope 540b, is within bull's eye 530b. Thus, as a result of the target-compensation adjustment, the player is given the impression, and in fact, receives the result for hitting a bull's eye despite the player's aim suggesting the player has a lower level of skill in aiming at the target.

In the exemplary aspects illustrated in FIGS. 5A and 5B, the player's input or aim is off to the left of the bull's eye 530a and slightly lower than the center of the target 510a. FIG. 5A illustrates the player receiving an award that is less than the highest award since the shot or input directed at target 510a receives no compensation due to the player placing a wager amount below a threshold value (e.g., just betting 1 per line; betting a single payline; betting below a threshold wager amount) for receiving a target compensation. As discussed above, the input associated with the shot in FIG. 5B is to the same point, but because there is a target compensation adjustment for being at or above a certain wager threshold (e.g., a wager level of 10 per line; betting 10 paylines; exceeding a certain total bet wager; other wager amounts) the size of the bulls-eye 530b is increased allowing for a greater award to the player. The degree of compensation can vary based on the player's wager level such that a wagering game can provide many different levels or degrees of target compensation adjustment depending on the wager level or wager amounts selected by a player.

It is contemplated that an increased wager that provides a skill-level adjustment does not necessarily increase proportionally to the amount of award the player may receive in the skill-based game. For example, an uncompensated skill-based game outcome can result in the player in FIG. 5A being awarded one amount (e.g., 80 credits awarded with a 1 credit per line bet in an underlying slots game). However, the compensated skill-based game outcome in FIG. 5B results in the player being awarded a higher amount that is not proportional to the player's increased wager (e.g., 100 credits awarded for a 10 credit per line bet in the underlying slots game rather than a ten-fold or some other significant increase in the awarded credits.) However, the benefit to the player by placing bets at the higher wager level is that there is an increased chance that the player will achieve a higher award than in an uncompensated skill-based game.

A desirable aspect of a target-compensation adjustment feature in a skill-based game includes the player feeling like their skill played a role in receiving a higher skill-based award. Thus, in some aspects of the present disclosure, it is contemplated that any compensation for a skill-based input received from a player (e.g., the expanded bull's eye in FIG. 5B) will not be displayed or otherwise made visible to the player in the display area for the skill-based game. For example, when compensation or adjustment is applied to a player's skill-based input in the exemplary aspect illustrated in FIGS. 5A and 5B, the target 510a may be displayed to the player, but the award may be based on the expanded bull's eye 530b illustrated by the target 510b. In some aspects, to visually show the adjustment to the player, the arrow may imperceivably move toward the bull's eye 530 despite the player's aim at the target ring 528a. In other aspects, imperceivable adjustments may be made to the player's aim via the cross-hairs in the scope so that the player believes they are aiming at the bull's eye despite their aim being slightly to outside of the bull's eye.

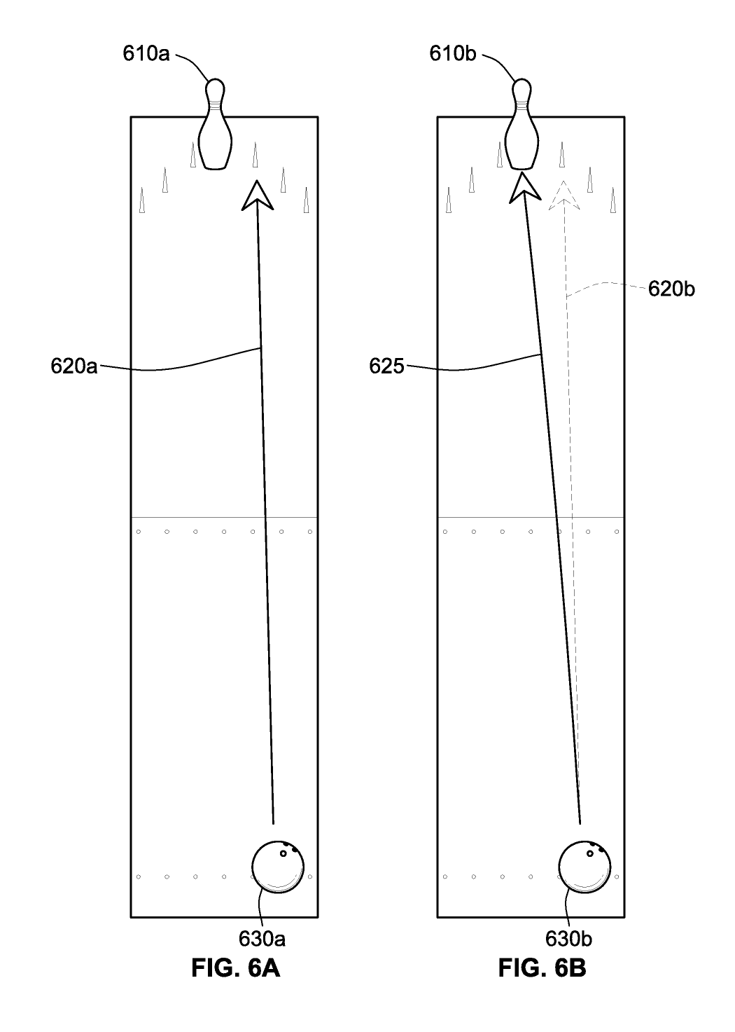

Referring now to FIGS. 6A and 6B, images of an exemplary skill-based game including a player-input compensation adjustment feature are illustrated. In some aspects of skill-based games, there may be instances where altering or adjusting a target so that the alteration is not perceivable to the player is not feasible. For example, in the exemplary bowling game in FIGS. 6A-6B, the target 610a, 610b (e.g., the bowling pins) may not be adjusted, as was done for example in FIG. 5B. Thus, to provide a compensation adjustment, it is contemplated the trajectory of a player's virtual bowling ball 630a, 630b based on a received player input may be compensated according to different compensation triggering factors, such as an increased wager. It is further contemplated that compensation to the trajectory of the player's ball throw is made gradually so the player is not aware of the compensation. For example, in FIG. 6B, the compensated trajectory 625 is illustrated along with the uncompensated trajectory 620b to show the gradual adjustments made to the trajectory of virtual bowling ball 630b as the ball progresses toward the target 610b. The uncompensated trajectory line 620b is the same as trajectory line 620a in FIG. 6A. Different variations of projectile-style skill-based games (e.g., bowling) are contemplated. That is, skill-based games other than bowling and the other skill-based games described herein are contemplated by the present disclosure.

In FIG. 6A, similar to FIG. 5A, if the player is wagering an amount below a certain threshold (e.g., in the context of an exemplary slots wagering game betting below a certain number of credits per payline or betting below a certain number of paylines; betting above a certain total wager threshold), the wagering game may be configured to provide no correction or compensation to a receive skilled-based input from a player. Then, based simply on the received player input, with no correction applied, the player's bowling ball 630a slides past the target 610a (e.g., pin) and completely misses it. If the player is betting above a triggering wager threshold (e.g., in the context of an exemplary slots wagering game betting above a certain number of credits per payline or betting below a certain number of paylines; betting above a certain total wager threshold), the wagering game will move the bowling ball 630b a certain number of boards (e.g., three to four boards) or provide a certain percentage correction (e.g., approximately ten percent) in the appropriate direction of the target to compensate for the player's lack of skill. The percentage correction may be based on the width of the field in which the target is situated (e.g., the width of the bowling lane) where the movement of the projectile toward the target is based on a certain percentage of the field width. The compensation does necessarily mean that the player will always shoot three boards or four boards to the left, but will instead simply adjust the player's throw of the ball so that the ball 630b curves or floats in an optimal direction (e.g., toward a pin).

It is further contemplated that in the exemplary aspects illustrated in FIGS. 5A-5B and 6A-6B that certain environmental factors may be present in skill-based games. For example, in the shooting target game of FIGS. 5A-5B, wind could be a component in the skill-based component of the wagering game that may be compensated for through a margin of error correction. In the example of the bowling game of FIGS. 6A-6B, warping or certain areas of the bowling lane that are more slippery may be environmental factors that can also be compensated for through margin of error correction(s). In another example, a skill-based game may be golf where wind, weather, and/or hazards may also be compensated for through margin of error corrections (e.g., adding spin to a shot to make the ball roll closer to the hole). The compensation will be invisible or imperceivable to the player so that the player feels as if the player's skill contributed to favorable outcomes being achieved in the skill-based game. Maintaining an invisible or imperceivable compensation can occur through compensation factors being applied gradually or non-adjusted targets being displayed though a bigger desired target is used to determine an award. It can be desirable for maintaining player appeal in a skill-based game that the player feels that their skill is what results in the achievement of an award or outcome. While the player input may be receiving some compensation through aspects described in the present disclosure, the player should feel or it should be observable to the player that their skill is still involved in the outcome of the skill-based game.

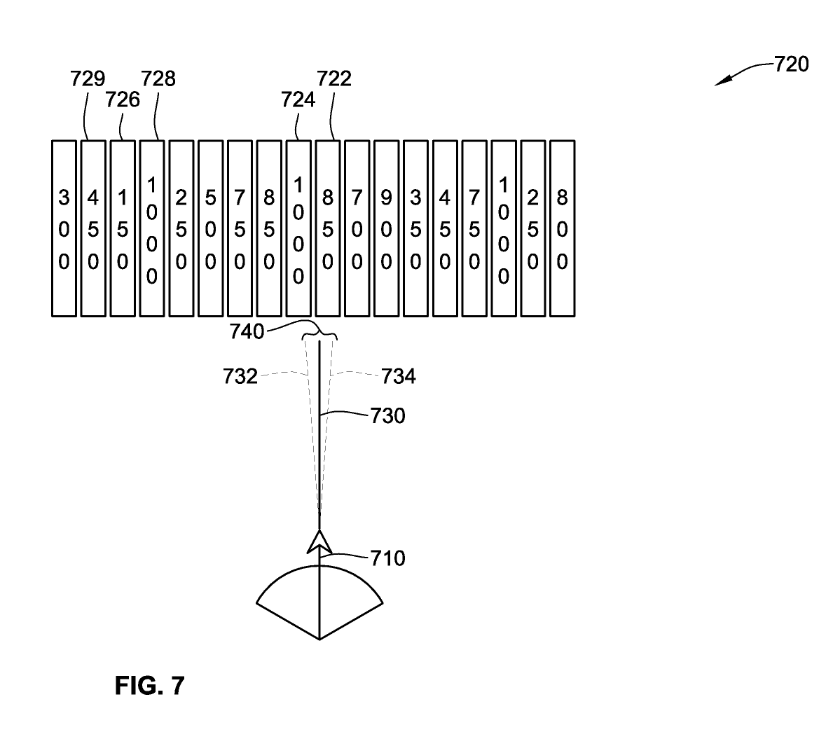

Referring now to FIG. 7, an image of another skill-based game demonstrating another player-input compensation adjustment feature is illustrated. In FIG. 7, the skill-based compensation is applied to the player's input, not to the field in general (e.g., FIG. 5). By applying the compensation to the player input, the challenge and feel of the skill-based game appears to be the same to players playing at different wagering levels. A player input is associated with shooting a virtual arrow 710 at several targets 720 that are lined up immediately next to each other where each of the targets award different values to the player. The actual physical input received from the player that fires the arrow (e.g., actual aim trajectory) is used as a baseline 730 for a margin of error zone 740 (e.g., applied margin of error). So, if the player were betting one credit per line, and receiving no compensation, the player would fire and hit the 850 credit target 722, almost in the middle of it. If the player is betting more, the player receives compensation which is shown by zone boundaries 732, 734 to the left and right of the actual aim trajectory established by the baseline 730.

The zone boundaries 732, 734 define the margin of error zone, which in the example of FIG. 7, covers beyond the left edge of target 722 to a 1,000 credit target 724. The zone also extends to the right of target 722, which in the example of FIG. 7, does not extend off of the 850 credit target 722. The player betting above a certain threshold in this example would be compensated by having the arrow float to the left of their actual aiming point and be awarded for hitting the 1,000 credit target 724 since the 1,000 credit target had the highest outcome within the margin of error zone defined by zone boundaries 732, 734. If the player had aimed a little bit to the right, so that the compensation would not extend to the 1,000 credit target on the left, but the compensation would reach the 700 credit target on the right, the game would then give the player their actual aiming point and have awarded the player the 850 credit associated with target 722. It is therefore contemplated that is some aspects the game will always award the player the best outcome within their compensation range.

The player's choice of where to fire or aim in FIG. 7 and the player's ability to fire or aim where the player actually wants to impacts the player's outcome in the skill-based game. For example, if the player is aiming at the 150 credit target 726, but is aiming a little bit off to the right of target 726, it is contemplated that the compensation will include a margin of error zone that awards the player the adjacent 1,000 credit target 728. However, if the player aims dead center on the 150 credit target 726, the compensation may not award the player anything to either side of target 726 because a dead center aim in the illustrated aspect may not extend beyond the width of the 150 credit target 726. So, to further illustrate this example, if the player aims a little left of center of the 150 credit target 726, it is contemplated that the compensation will award the player the adjacent 450 credit target 729. Thus, a wager-based adjustment to a skill-based game can still result in a player receiving a less than optimal or even a worse outcome because of a player's lack of skill. While generally all the outcomes may be available to a player in a skill-based game including a skill-compensation feature, aspects of the present disclosure also contemplate compensating an input received from the player when the player's input is slightly off target to move or increase a player's chances for a favorable outcome.

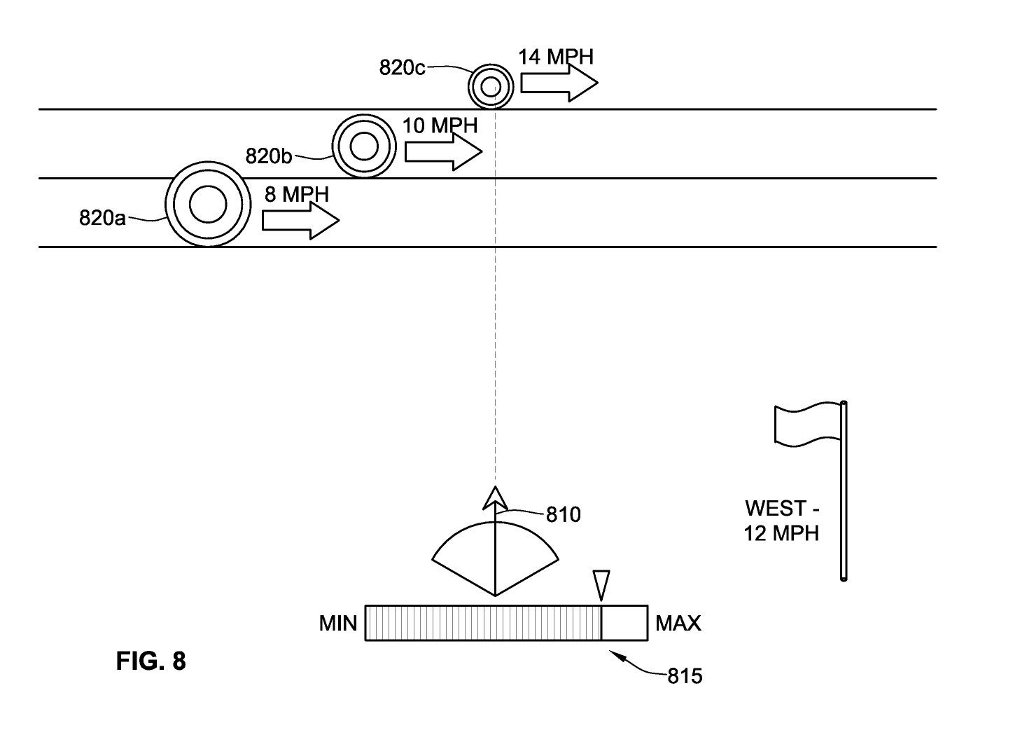

Turning now to FIG. 8, an exemplary skill-based game is illustrated where certain environmental factors affect a player's skill-based input. An exemplary skill-based game based on archery is illustrated in which a player provides an input associated with aiming a projectile 810 (e.g., arrow) at one of a plurality of virtual targets 820a, 820b, 820c that have the appearance of being downrange from a virtual bow. The player is awarded for his arrow hitting the rings of a target 820a, 820b, 820c, with the bull's-eye of the farthest target providing the top award. There are several factors aside from the player's aim that may affect the outcome including wind speed (e.g., 12 mph) and direction (e.g., west), speed of the fired projectile (e.g., the faster the arrow flies, the closer the impact point will be to the aiming point and the less the effects of gravity), the speed of moving target(s), and/or random changes in direction of moving target(s) (e.g., targets might change direction randomly if the minimum bet is made and change direction less often with higher bets). For example, in addition to aim of the virtual arrow, other player inputs may be received, such as an input indicative of the power behind the player's shot as illustrated by power bar 815 which includes a slider for adjusting the power of the player's shot between a minimum and maximum value.

Each of the factors can be adjusted, or even eliminated, when a player increases their wager to meet or exceed certain wagering levels that reduce the external factors impacting the player's input. Thus, as the player increases his wager and exceeds certain wager levels, less skill is needed to achieve a desired or optimal outcome since the higher wager reduces the external or environmental factors that may be applied by the wagering game to the skill-based game. The decrease in needed skill can allow the player to more easily hit a target (e.g., 820a, 820b, 820c) based on the received input indicative of the player's aim at the target rather than the player having to otherwise aim to account for one or more of the external factors. It is also contemplated that compensation applied in the exemplary aspect of FIG. 8 can include countering a west wind by applying a balancing east wind (e.g., 8 mph, 10 mph, 14 mph) or increasing the target size thereby increasing the chances the received input indicative of a player's hits a target.

In some aspects of skill-based games, a wager-based adjustment may be made to the game to compensate for a player's skill by removing factors that impact a received player input. For example, if a skill-based game includes shooting an arrow at a target, such as in FIG. 7 or 8, a received bet that is below a threshold level for compensating a player input may require a player to apply their skills to account for certain factors affecting their input. The factors can include wind or obstacles, such as target(s) that need to be shot over or around. However, as the received bet increases, the player may meet or exceed certain wagering levels such that compensation(s) are made to the player input. The compensation(s) can include compensating for one or more of the factors impacting the player's uncompensated input. For example, one or more of the factors impacting the player's input may be reduced or removed thereby allowing the player's actual aim trajectory to be more of a straight line. Other exemplary aspects of factors whose effect can be minimized include in the exemplary context of the bowling game in FIG. 6, where a player may need to account for an oil pattern in the bowling lane. The player may need to add spin and hook to their virtual bowling ball to hit a target. However, by receiving compensation and a wager-based adjustment, the oil pattern may be less complex, reduced, or removed such that the player's aim is more representative of where the ball will hit the bowling pin target(s) or compensation may be applied in the form of spin to the ball to account for the oil pattern hazard.

The removing or compensating for post-input factors or invisible variability factors include factors that are applied after a player's skill-based input is received. In an uncompensated skill-based game, the system takes the input from the player and the player's skill-based input is then used to determine a final outcome of the game (e.g., hitting a particular target). In such skill-based games, environmental factors such as spin, wind, magnetic targets, or other factors can be applied after the player's input is received. The gaming system can then either use applied factors and compensate a player for lack of skill on their input, or the system can remove the applied factors in order to adhere to the player's input more directly.

In some aspects, other types of compensation are described in the context of an exemplary golf-based game of skill. If a player bets below a compensation or skill-based adjustment threshold, it is contemplated that many factors, such as the speed of the player's swing, the angle of the golf club, the spin placed on the golf ball, the wind, and/or other factors may need to be accounted for by the player to hit a certain target with the golf ball. However, if the player increases his betting above the threshold (e.g., max betting, certain intermediate wager levels between the minimum and maximum bet, a certain total wager amount for a wagering game round, a gradually increasing amount of skill-compensation that increases with increasing wager levels) for receiving compensation, one or more of the factors may be removed or the skill-level decreased. For example, it may simply be the speed of the player's club is all that the system takes into account through a compensation that removes the other factor(s) or gives the player the optimal outcome for all the other factor(s). Thus, in the exemplary aspect of a golf-based game, the player receiving a wager-based skill adjustment may only need to be concerned with applying the correct speed to his club swing, rather than accounting for one or more additional factors.

The aspects described in FIGS. 5-8 include a player aiming at a virtual object or directing a virtual object in a physical manner such that skill-compensation is generally based on a physical input being received from a player. It is also contemplated by the present disclosure that a skill-based game provides for wager-based compensations to be applied to strategic decisions made by a player.

In some aspects, the skill-based game can be bonus events to a primary or base wagering game, such as a slots game. For example, a gaming system may include play of a typical slots game and the player may be betting a wager that is larger than the minimum wager or may be betting the maximum bet. Then, there may be a bonus trigger where the player can play the skill-based bonus game where a wager-based skill adjustment is made to compensate for a player's skill and increase the player's chance of winning larger skill-based awards.

It is further contemplated that skill-based game(s) may be base wagering game(s). For example, a player may wager on shooting a target, such as the targets illustrated in FIGS. 5-8. The awards for hitting a target can then be scaled appropriately relative to a player's wager so that the player is not always winning more than the player's wager. It is further contemplated that the awards are commensurate in size with the player's wager.

In some aspects of the present disclosure, a gaming system includes one or more input devices, one or more display devices, one or more processors, and one or more memory devices storing instructions that, when executed by the one or more processors, cause the gaming system to receive, via at least one of the one or more input devices, a wager input indicative of a wager to play a wagering game including a skill-based game. A skill-based input indicative of play of the skill-based game is received via at least one of the one or more input devices. A skill-level adjustment is applied to the skill-based game to decrease the skill-level needed to achieve an award outcome in the skill-based game. The skill-level adjustment includes compensating for the received skill-based input. An outcome of the skill-based game is determined. The outcome is based at least in part on the compensating for the received skill-based input. In response to the outcome being an award outcome, an award is provided for the skill-based game.

In some aspects of the present disclosure, a computer-implemented method in a gaming system includes receiving, via at one or more input devices, a wager input indicative of a wager. In response to receiving the wager input, a wagering game including a skill-based game is displayed on one or more display devices. A skill-based input indicative of play of the skill-based game is received via at least one of the one or more input devices. A skill-level adjustment to the skill-based game is determined via one or more processors. The skill-level adjustment decreases the skill-level needed to achieve an award outcome in the skill-based game by applying a compensation for the received skill-based input. An outcome of the skill-based game is determined via at least one of the one or more processors. The outcome is based at least in part on the compensation for the skill-based input. In response to the outcome being an award outcome, an award for the skill-based game is provided via at least one of the one or more processors.

In some aspects of the present disclosure, one or more physical machine-readable storage media including instructions which, when executed by one or more processors, cause the one or more processors to perform operations comprising receiving, via at one or more input devices, a wager input indicative of a wager. In response to receiving the wager input, a wagering game including a skill-based game is displayed on one or more display devices. A skill-based input indicative of play of the skill-based game is received via at least one of the one or more input devices. A skill-level adjustment to the skill-based game is determined via at least one of the one or more processors. The skill-level adjustment decreases the skill-level needed to achieve an award outcome in the skill-based game by applying a compensation for the skill-based input. An outcome of the skill-based game is determined via at least one of the one or more processors. The outcome is based at least in part on the compensation for the skill-based input. In response to the outcome being an award outcome, an award for the skill-based game is determined via at least one of the one or more processors.

It is contemplated that some aspects of the gaming systems, methods, and operations described above include one or more of the following features.

In some aspects, the skill-based game can be a bonus game. The wagering game can also include a base slots game and the skill-based game can be a bonus game played in response to a bonus trigger in the base slots game.

In some aspects, a decrease in the skill-level needed to achieve an award outcome can be proportional to an amount that the wager exceeds a threshold wager amount. The skill-level adjustment can be also be based on the received wager input such that the more a wager exceeds a threshold wager amount the greater the decrease in the skill-level needed to achieve an award outcome in the skill-based game. A skill-level adjustment can also be applied to the skill-based game in response to the wager meeting or exceeding one or more of a plurality of wager levels. The extent of the skill-level adjustment can also be based on a received wager amount such that the greater the received wager amounts the greater the decrease in the skill-level needed to achieve the award outcome in the skill-based game.

In some aspects, the skill-level adjustment includes increasing a target size thereby decreasing the skill-level needed for the skill-based input to cause a target to be hit in the skill-based game. The increasing of the target size may not be visible on the one or more display devices displaying the skill-based game.

In some aspects, the skill-level adjustment includes an increased margin of error for the skill-based input. The increased margin of error causes the award outcome to be achieved in the skill-based game. The skill-level adjustment can also include applying a compensation correction to the received skill-based input thereby providing an increased chance of achieving the award outcome in the skill-based game in response to the skill-based input.

In some aspects, the skill-based game includes a plurality of secondary inputs indicative of play of the skill-based game. The skill-level adjustment includes adjusting at least one of the plurality of secondary inputs to an optimal input to cause an increased chance of achieving the award outcome in the skill-based game. The skill-based game can also include one or more non-player controlled factors affecting the outcome. The skill-based adjustment eliminates one or more of the non-player controlled factors thereby decreasing the skill-level needed to achieve an award outcome that is higher than another award outcome achieved without the skill-based adjustment. The skill-based game can also include modifying the skill-based game environment after receiving the skill-based input. The skill-based adjustment can include a margin of error correction to the skill-based input to compensate for the modifying of the skill-based environment thereby decreasing the skill-level needed to achieve the award outcome.

In some aspects, the skill-based game can be selected from the group consisting of a virtual shooting game, a virtual archery game, a virtual bowling game, a virtual golf game, a virtual pinball game, and a virtual bombing game.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

1. A gaming system comprising:
one or more input devices;
one or more display devices;
one or more processors; and
one or more memory devices storing instructions that, when executed by the one or more processors, cause the gaming system to:
receive, via at least one of the one or more input devices, a wager input indicative of a wager to play a wagering game including a skill-based game;
receive, via at least one of the one or more input devices, a skill-based input indicative of play of the skill-based game;
apply a skill-level adjustment to the skill-based game to decrease the skill-level needed to achieve an award outcome in the skill-based game, the skill-level adjustment including compensating for the received skill-based input;
determine an outcome of the skill-based game, the outcome based at least in part on the compensating for the received skill-based input; and
in response to the outcome being the award outcome, provide an award for the skill-based game.

2. The gaming system of claim 1, wherein the skill-based game is a bonus game.

3. The gaming system of claim 1, wherein the wagering game includes a base slots game and the skill-based game is a bonus game played in response to a bonus trigger in the base slots game.

4. The gaming system of claim 1, wherein the decrease in the skill-level needed to achieve an award outcome is proportional to an amount that the wager exceeds a threshold wager amount.

5. The gaming system of claim 1, wherein the skill-level adjustment is based on the received wager input such that the more a wager exceeds a threshold wager amount the greater the decrease in the skill-level needed to achieve the award outcome in the skill-based game.

6. The gaming system of claim 1, wherein the skill-based game includes a target and the skill-level adjustment includes increasing a size of the target thereby decreasing the skill-level needed for the skill-based input to cause the target to be hit during the skill-based game.

7. The gaming system of claim 6, wherein the increasing of the size of the target is not visible on the one or more display devices configured to display the skill-based game.

8. The gaming system of claim 1, wherein the skill-level adjustment includes an increased margin of error for the skill-based input, the increased margin of error causing the award outcome to be achieved in the skill-based game.

9. The gaming system of claim 1, wherein the skill-level adjustment includes applying a compensation correction to the received skill-based input thereby providing an increased chance of achieving the award outcome in the skill-based game.

10. The gaming system of claim 1, wherein the skill-based game includes a plurality of secondary inputs indicative of play of the skill-based game, the skill-level adjustment including adjusting at least one of the plurality of secondary inputs to an optimal input to cause an increased chance of achieving the award outcome in the skill-based game.

11. The gaming system of claim 1, wherein the skill-based game includes one or more non-player controlled factors affecting the outcome, the skill-based adjustment eliminating one or more of the non-player controlled factors thereby decreasing the skill-level needed to achieve an award outcome, the award outcome being higher than another award outcome that would otherwise be achieved without the skill-based adjustment.

12. The gaming system of claim 1, wherein the skill-based game includes modifying the skill-based game environment after receiving the skill-based input, the skill-level adjustment including a margin of error correction to the skill-based input to compensate for the modifying of the skill-based environment thereby decreasing the skill-level needed to achieve the award outcome.

13. The gaming system of claim 1, wherein the skill-based game is a virtual game selected from the group consisting of a shooting game, an archery game, a bowling game, a golf game, a pinball game, and a bombing game.

14. The gaming system of claim 1, wherein a skill-level adjustment is applied to the skill-based game in response to the wager meeting or exceeding one or more of a plurality of wager levels.

15. A computer-implemented method in a gaming system, the method comprising:
receiving, via one or more input devices, a wager input indicative of a wager;
in response to receiving the wager input, displaying on one or more display devices a wagering game including a skill-based game;
receiving, via at least one of the one or more input devices, a skill-based input indicative of play of the skill-based game;
determining, via one or more processors, a skill-level adjustment to the skill-based game, the skill-level adjustment decreasing the skill-level needed to achieve an award outcome in the skill-based game by applying a compensation for the received skill-based input;
determining, via at least one of the one or more processors, an outcome of the skill-based game, the outcome based at least in part on the compensation for the skill-based input; and
in response to the outcome being the award outcome, provide via at least one of the one or more processors an award for the skill-based game.

16. The computer-implemented method of claim 15, wherein the skill-level adjustment is based on a received wager amount such that the greater the wager the greater the decrease in the skill-level needed to achieve the award outcome in the skill-based game.

17. The computer-implemented method of claim 15, wherein the skill-level adjustment includes applying a compensation correction to the received skill-based input thereby providing an increased chance of achieving the award outcome in the skill-based game.

18. The computer-implemented method of claim 15, wherein the skill-based game includes a plurality of secondary inputs indicative of play of the skill-based game, the skill-level adjustment including adjusting at least one of the plurality of secondary inputs to an optimal input to cause an increased chance of achieving the award outcome in the skill-based game.

19. The computer-implemented method of claim 15, wherein the skill-based game includes modifying the skill-based game environment after receiving the skill-based input, the skill-based adjustment including a margin of error correction to the skill-based input to compensate for the modifying of the skill-based environment thereby decreasing the skill-level needed to achieve the award outcome.

20. One or more physical machine-readable storage media including instructions which, when executed by one or more processors, cause at least one of the one or more processors to perform operations comprising:
receiving, via at one or more input devices, a wager input indicative of a wager;
in response to receiving the wager input, displaying on one or more display devices a wagering game including a skill-based game;
receiving, via at least one of the one or more input devices, a skill-based input indicative of play of the skill-based game;
determining, via at least one of the one or more processors, a skill-level adjustment to the skill-based game, the skill-level adjustment decreasing the skill-level needed to achieve an award outcome in the skill-based game by applying a compensation for the skill-based input;
determining, via at least one of the one or more processors, an outcome of the skill-based game, the outcome based at least in part on the compensation for the skill-based input; and
in response to the outcome being the award outcome, determining via at least one of the one or more processors an award for the skill-based game.
